(19) United States
(12) Patent Application Publication
(10) Pub. No.: US 2007/0062325 A1
(43) Pub. Date: Mar. 22, 2007

(54) Manually operated electric control device

(75) Inventors: Werner Steprath, Dormagen (DE); Judith Dreyling, Schwieberdingen (DE)

Correspondence Address: OLIFF & BERRIDGE, PLC, P.O. BOX 19928, ALEXANDRIA, VA, 22320, US

(73) Assignee: Bosch Rexroth AG, Stuttgart (DE)

(21) Appl. No.: 10/574,011

(22) PCT Filed: Sep. 29, 2004
(86) PCT No.: PCT/DE04/02170

§ 371 Date: Aug. 1, 2006

(30) Foreign Application Priority Data
Oct. 4, 2003 (DE) 10346103.5
Jan. 27, 2004 (DE) 102004004041.9

(51) Int. Cl. G05G 1/04

(52) U.S. Cl. 74/523

(57) ABSTRACT

There is disclosed a manually operated electric control device wherein a control lever is mounted by means of a universal joint type pivotable joint. Said control device has two axes which can be pivoted in relation to each other. One axis is formed by a bearing bush in which two bearing sections of the pivotable joint are guided. Bearing tappets are arranged on the bearing sections via which the control lever can be pivoted about another axis.

The invention relates to a manually operated electric control device in accordance with the preamble of claim 1.

Electric control devices of this type—also referred to as joysticks—are used for the proportional adjustment of hydraulic valves or hydraulic consumers, for instance in mobile machines.

From DE 199 60 757 A1 a control device is known in which a control lever is supported on a housing via a ball joint. This ball joint practically admits pivoting of the control lever to all sides, the control device being designed such that two main pivot planes, for instance for adjusting the velocity and the driving direction of a hydraulic chassis drive are provided. During cornering this control lever can be adjusted in intermediate positions between the two main pivot planes. The pivoting movement of the control lever is detected via a sensing technology, for instance via a permanent magnet accommodated in the pivoting lever and magnetic field sensors fixedly mounted in the housing. In order to prevent the control lever from being twisted about its longitudinal axis, in the known control device a pin supported in the housing is provided which immerses in a tangential groove of the control lever.

What is difficult in such a solution is the fact that considerable wear of the frictional surfaces between the tangential groove and the pin may occur. This wear entails a noticeable torsion play of the support of the control lever, which, in turn, can result in a certain roughness when controlling the consumer.

A similar solution having the same drawbacks is known from EP 0 459 183 A1.

In U.S. Pat. No. 5,619,195 a control device is shown in which the control lever is supported via a universal joint having two pivot axes which can be pivoted at 90° in relation to each other. Universal joints of this type—also referred to as cardan joints—likewise permit pivoting of the control lever to all sides. In the known solution the universal joint is formed by three rings disposed inside each other, an inner cardan ring being connected to the control lever and being supported by two diametrally projecting tappets in seats of an intermediate ring. The latter includes two further seats arranged orthogonally to the two seats for the inner cardan ring, in which further seats an outer cardan ring is supported by two bearing journals arranged on its inner surfaces diametrally with respect to each other. This control lever is protected against torsion by an appropriate mounting of the lever to the inner cardan ring.

In such a design, on the one hand, the very complex structure of rings arranged inside each other is a drawback and moreover the fact that a considerable building space must be provided in the control device is disadvantageous. Furthermore, the arrangement of the sensing technology is solved in a comparatively complicated way, because the magnetic field sensors are accommodated in a sensor carrier which is inserted in the outer cardan ring and the permanent magnets are fastened in said pivot journals.

In contrast to that, the object underlying the invention is to provide a manually operated electric control device which has a simple structure and permits pivoting about a longitudinal axis of a control lever of the control device with sufficient protection against torsion.

This object is achieved by a manually operated electric control device in accordance with the features of claim 1.

In accordance with the invention, the control device comprises a universal joint type pivotable joint having two axes which can be pivoted in relation to each other, a first pivot axis being formed by two bearing tappets mounted indirectly or directly on the control lever or immersing in the same. Each of the latter is supported and fastened, resp., in a bearing section which, in turn, is guided with its outer surfaces in a bearing bush so that the second pivot axis of the universal joint type pivotable joint is defined by the bearing bushes and the outer surfaces of the bearing sections. A high quality feeling is subjectively conveyed by the surface contact of the bearing sections with the bearing bushes enclosing the same. Moreover in such a design the control lever is reliably prevented from twisting about its longitudinal axis. The solution according to the invention furthermore excels by an extremely compact structure, wherein the manufacture and assembly can be carried out at low effort and cost.

The manufacturing effort can be further reduced, when the bearing sections and the bearing bushes are provided with cylindrical sliding surfaces, i.e. the bearing sections are formed by cylinder sections and the bearing bushes are formed by a cylinder bush. With such a solution the quality feeling is especially high due to the large-surface support.

The manufacture and assembly of the cylinder bush is especially simple when it is made of two bush members connected by a bridge. Such a component can be simply manufactured of plastic material by injection molding.

The bearing tappets forming the first pivot axis are received either slidingly in the control lever or in the bearing section and are appropriately fixed in the respective other component by press-fit or by gluing etc.

An especially reliable guiding is ensured when the cylinder bushes most largely cover the two cylinder portions in the pivoting direction, wherein the axial length of the cylinder portions and the cylinder bushes is chosen to be equal so that they can be jointly fixed in a seat of the housing.

In a preferred embodiment the control lever is extended at the bottom side to form a seat for the sensing technology, for instance for a permanent annular magnet. The manufacture is especially simple when this bottom-side end portion of the control lever is rectangular, wherein the bearing tappets mentioned in the beginning project from two opposed rectangular end faces serving as sliding surfaces for the plane bearing faces of the cylinder portions.

The components of the pivotable joint are preferably manufactured of non-magnetizable material.

Other advantageous further developments of the invention are the subject matter of further subclaims.

Hereinafter a preferred embodiment of the invention is illustrated in detail by way of schematic drawings, in which

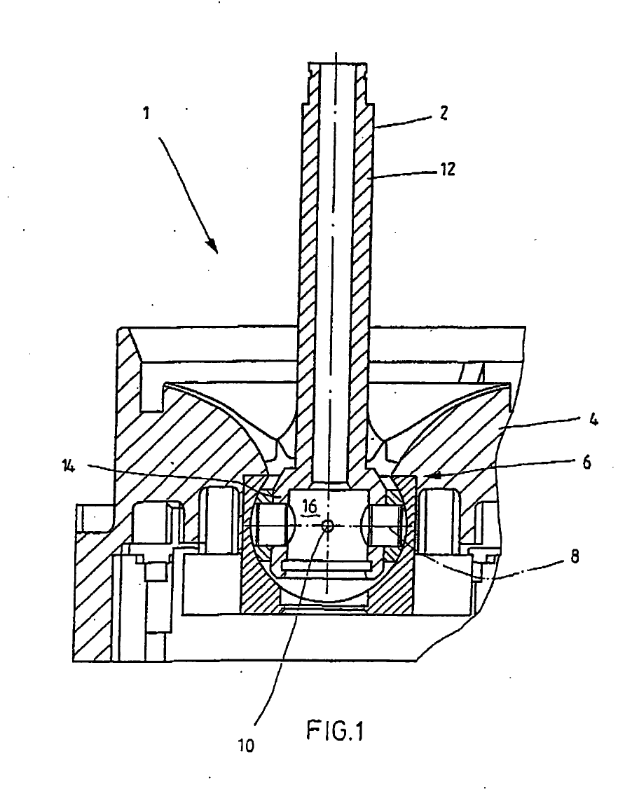

FIG. 1 shows a section across a part of a manually operated electric control device;

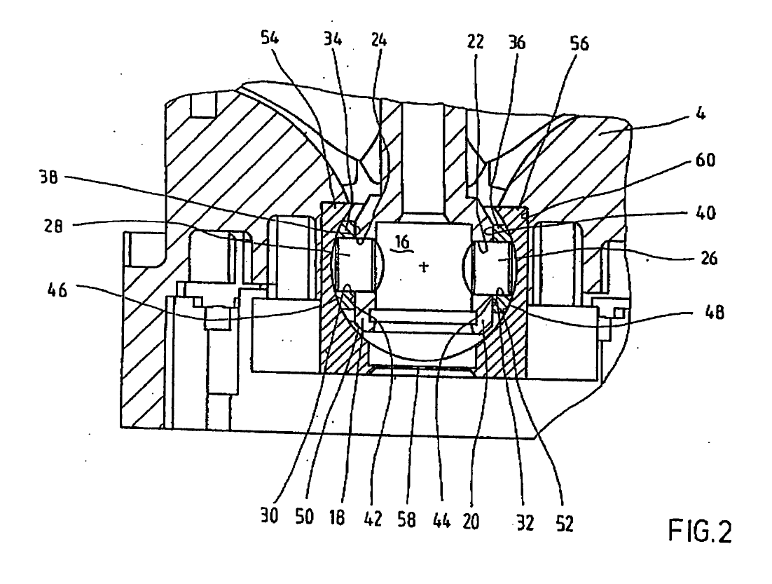

FIG. 2 shows a detailed view of the control device from FIG. 1;

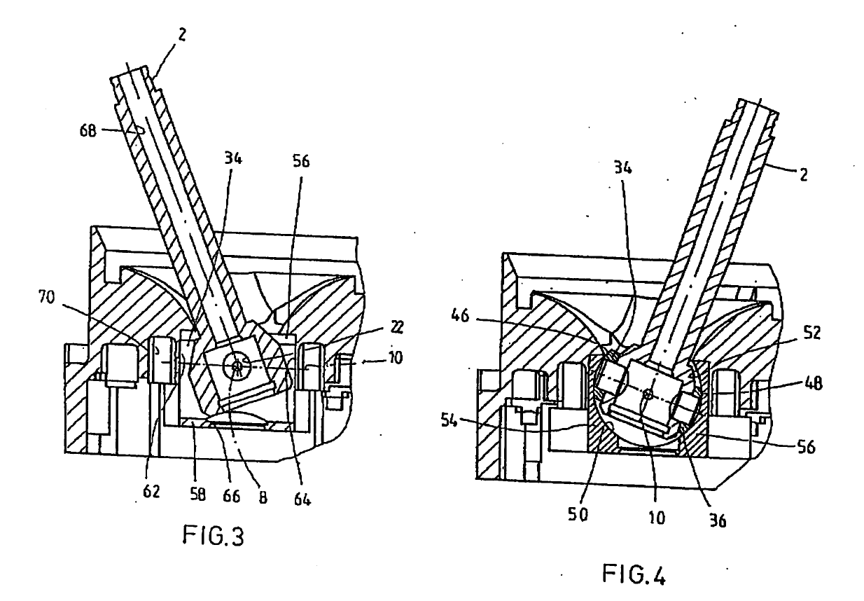

FIG. 3 shows a section offset by 900 across a control device according to FIG. 1 and

FIG. 4 is a representation corresponding to FIG. 1 comprising a pivoted control lever.

In FIG. 1 a longitudinal section across a part of a manually operated electric control device 1 of a mobile machine is represented. By means of said control device 1, for instance, the driving speed and the driving direction of a chassis drive, the speed and the direction of movement of an extension arm etc. can be controlled. The only partly represented control device 1 comprises a control lever 2 supported in an upper housing part 4 by means of a universal joint type pivotable joint 6. Said pivotable joint 6 has two pivot axes located in a plane and adapted to be pivoted by 90° in relation to each other, a first pivot axis 8 of which is located within the plane of projection and a second pivot axis 10 extends perpendicularly to the plane of projection (cf. also FIG. 3). This pivotable joint 6 is designed such that the pivoting lever 2 is pivotable to all sides, but it has two main pivot planes which are defined by the two axes 8, 10. I.e. one main pivot plane is located in the plane of projection and is defined by the pivot axis 10, while the other main pivot plane extends perpendicularly to the plane of projection and is predetermined by the pivot axis 8.

The control lever 2 has a cylindrical body 12 that is extended toward the pivotable joint 6 into an approximately rectangular base 14. Therein a receiving chamber 16 is provided into which an annular permanent magnet can be inserted. As one can take from the detailed representation according to FIG. 2, each of the side walls 18, 20 extending perpendicularly to the plane of projection in FIG. 1 is provided with a breakthrough 22 and 24, resp., into which respective bearing tappets 26, 28 are inserted. The bearing tappets 26, 28 are arranged coaxially with respect to the pivot axis 8. In the described embodiment it is assumed that the bearing tappets 26, 28 are inserted in the breakthroughs 22, 24 with press fit.

The end portions of the bearing tappets 26, 28 projecting from the side walls 18, 20 immerse in bearing seats 30, 32 of cylinder sections 34, 36 which are adjacent to the external faces 42, 44 of the side walls 18, 20 of the base 14 of the control lever 2 with their plane bearing surfaces 38, 40 facing the base 14.

The external surfaces 46, 48 are cylinder surfaces disposed coaxially with respect to the pivot axis 10 and are adjacent to appropriately designed internal cylinder surfaces 50, 52 of two bush members 54, 56. These are connected to each other by a bridge 58 arranged at the bottom in FIG. 2 so that an integral cylinder bush is formed.

Said cylinder bush in inserted from the bottom (FIG. 1) into a housing seat 60 of the upper housing part 4 and is fixed in position in the direction of the axis of the control lever and transversely thereto. Said housing seat 60 has approximately the dimensions which would have to be provided for receiving a conventional ball joint, as described, for instance, in DE 199 60 757 A1. I.e. the pivotable joint 6 has an extremely compact design.

As it is resulting especially from the sectional representation according to FIG. 3, the cylinder sections 34, 36 and the pertinent bush members 54, 56 have the same axial length (related to the second pivot axis 10) and are supported in axial direction by the supporting surfaces 62, 64 confining the housing seat 60 at the front side (cf. FIG. 3).

The bridge 58 is provided with a breakthrough 66 through which electric signal lines of the control device can be guided. For the same purpose, the control lever 2 has an axial bore 68 via which said feed lines are guided from the bottom to a handle (not shown) of the control lever 2 at which the electric switches or the like is arranged for actuating consumers.

The magnetic field sensors associated with the permanent magnet disposed in the receiving chamber 16 are accommodated in an annular groove 70 or in plural bores distributed along the periphery which are likewise cabled from the bottom.

The particular advantage of the universal joint type pivotable joint 6 according to FIG. 2 resides in the fact that the surfaces sliding off each other (internal cylinder surfaces 50, 52/external cylinder surfaces 46, 48 and bearing surfaces 38, 40/end faces 42, 44) have a large-area design so that a very exact guiding is ensured which subjectively conveys a good quality feeling. The wear of these bearing surfaces is negligible so that the adjusting signal of the operating person can be converted to adjusting signals for the hydraulic consumers almost without error even after a long period of use.

In accordance with FIG. 1 the upper housing part 4 is provided with an ascending link guide 72 extending approximately cross-shaped along which a spring-biased readjusting member (not shown) is guided. By this readjusting member the control lever 2 is automatically returned to its neutral position upon release. Such readjusting members are known from prior art, for instance from DE 199 60 757 A1, so that further explanations are superfluous.

Said neutral position is shown in FIG. 1. In the representation according to FIG. 4 the control lever 2 is pivoted out of the neutral position to the right about the second pivot axis 10 for instance for steering a mobile machine. During this pivoting movement the two cylinder sections 34, 36 slide off the internal cylinder surfaces 50, 52 with their external surfaces 46, 48. The height (view according to FIG. 4) of the bush members 54, 56 is selected such that in the maximum pivoting position (FIG. 4) the cylinder sections 34, 36 are guided completely or at least along the majority of their external surface 46, 48.

In the sectional view according to FIG. 3 the control lever 2 is pivoted, vis-à-vis the representation according to FIG. 1, about the axis 8. This pivoting is performed about the two bearing tappets 26, 28, wherein the end faces 42, 44 of the base 14 of the control lever 2 slide off the bearing surfaces 38, 40 of the cylinder sections 34, 36. Of course, also both pivoting movements (about the axes 8, 10) can be superimposed so that intermediate positions of the pivoting positions shown in the FIGS. 3 and 4 are adjustable.

The components of the pivotable joint 6 as well as of the control lever 2 are preferably manufactured of non-magnetizable material in order to avoid errors of measurement of the sensing technology.

There is disclosed a manually operated electric control device wherein a control lever is mounted by means of a universal joint type pivotable joint. Said control device has two axes which can be pivoted in relation to each other. One axis is formed by a bearing bush in which two bearing sections of the pivotable joint are guided. Bearing tappets are arranged on the bearing sections via which the control lever can be pivoted about another axis.

### LIST OF REFERENCE NUMERALS

1 Control device
2 control lever
4 upper housing part
6 pivotable joint
8 1st pivot axis
10 2nd pivot axis
12 body
14 base
16 receiving chamber
18 side wall
20 side wall
22 breakthrough
24 breakthrough
26 bearing tappet
28 bearing tappet
30 seat
32 seat
34 cylinder section
36 cylinder section
38 bearing surfaces
40 bearing surfaces
42 end faces
44 end faces
46 external surface
48 external surface
50 internal cylinder surface
52 internal cylinder surface
54 bush member
56 bush member
58 bridge
60 housing seat
62 supporting surface
64 supporting surface
66 breakthrough
68 axial bore
70 annular groove
72 link guide

1. A manually operated electric control device comprising a housing on which a control lever is mounted by means of a universal joint type pivotable joint having two axes which can be pivoted in relation to each other, wherein the position of the control lever can be detected by a sensing technology for generating a control signal and wherein a first pivot axis is formed by two bearing tappets operatively connected to the control lever, characterized in that the bearing tappets immerse in respective bearing sections which are guided with their external surfaces in a bearing bush so that a second pivot axis is formed.

2. A control device according to claim 1, wherein each bearing section includes a cylinder section having a plane bearing surface adapted to be adjacent to end faces of the control lever and a convexly curved external cylinder surface adapted to be adjacent to a correspondingly designed concavely curved internal cylinder surface of the bearing bush having the form of a cylinder bush.

3. A control device according to claim 2, wherein the cylinder bush includes two bush members connected to each other by a bridge.

4. A control device according to claim 2, wherein the bearing tappets are supported to slide in the control lever or in the respective cylinder section and are fastened in the respective other component with press fit or the like.

5. A control device according to claim 2, wherein in a neutral position of the control lever the cylinder bushes extend beyond the cylinder sections in the direction of the longitudinal axis of the control lever.

6. A control device according to claim 2, wherein the axial length of the cylinder sections and of the cylinder bush is equal and the same are supported in a housing seat.

7. A control device according to claim 1, wherein the control lever has a receiving chamber for a permanent magnet at the base side.

8. A control device according to claim 7, wherein the control lever has an approximately rectangular base on which the end faces associated with bearing surfaces are formed.

9. A control device according to claim 1, wherein the components of the pivotable joint and the control lever are manufactured of non-magnetizable material.
